(19) United States
(12) Patent Application Publication
(10) Pub. No.: US 2015/0077223 A1
(43) Pub. Date: Mar. 19, 2015

(54) CODE VERIFICATION

(71) Applicant: INTERNATIONAL BUSINESS MACHINES CORPORATION, Armonk, NY (US)

(72) Inventor: Stephen D. Pipes, Winchester (GB)

(21) Appl. No.: 14/478,598

(22) Filed: Sep. 5, 2014

(30) Foreign Application Priority Data
Sep. 19, 2013 (GB) 1316649.1

(51) Int. Cl. G07C 9/00

(52) U.S. Cl. CPC G07C 9/00142
USPC 340/5.54

(57) ABSTRACT

A method and/or computer program product verifies code. An input of an access code is received. A passcode comprising a set of one or more code elements is retrieved, wherein one or more of the code elements are associated with a respective time period. An input access code is compared to the retrieved passcode. In response to the input access code matching the passcode, a verification of the access code is output.

### BACKGROUND

The present invention relates to code verification.

Access control systems are provided for controlling access to various types of tangible assets or resources such as physical spaces, plant, facilities or objects or to intangible assets or resources such as data or software. Access control systems commonly require the input of a predetermined access code in order to provide access to the relevant asset or resource. If an input access code matches a predetermined passcode known to the access control system then access to the relevant asset or resource is enabled.

One problem with access codes is that less complex codes, such as short case-insensitive number sequences, are easily compromised or guessed by an unauthorized user. Conversely more complex codes, such as longer case-sensitive character sequences, are often difficult for a user to remember.

### SUMMARY

In one embodiment of the present invention, a code verification apparatus comprises: a code input device for inputting an access code; a passcode retrieval hardware component for retrieving a passcode; and a verification logic operable to: compare an input access code to a retrieved passcode, and in response to the access code matching the passcode, output verification of the access code, wherein the passcode comprises a set of one or more code elements, and wherein one or more of the code elements are associated with a respective time period.

In one embodiment of the present invention, a method and/or computer program product verifies code. An input of an access code is received. A passcode comprising a set of one or more code elements is retrieved, wherein one or more of the code elements are associated with a respective time period. An input access code is compared to the retrieved passcode. In response to the input access code matching the passcode, a verification of the access code is output.

### BRIEF DESCRIPTION OF THE SEVERAL VIEWS OF THE DRAWINGS

Embodiments of the invention will now be described, by way of example only, with reference to the following drawings in which:

FIG. 1 is a schematic representation of a computer system comprising an access control application program for controlling access to an asset or resource in the form of an operating system for a computer;

FIG. 2 is a schematic representation of the functional elements of the access control application program of FIG. 1;

FIG. 3 is a flow chart illustrating the processing performed by the access control application program of FIG. 1 to capture an input access code;

FIG. 4 is a flow chart illustrating the processing performed by the access control application program of FIG. 1 in response to a captured access code; and

FIG. 5 is another embodiment in which access control logic is arranged to control access to an asset or resource via a physical door lock controller.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

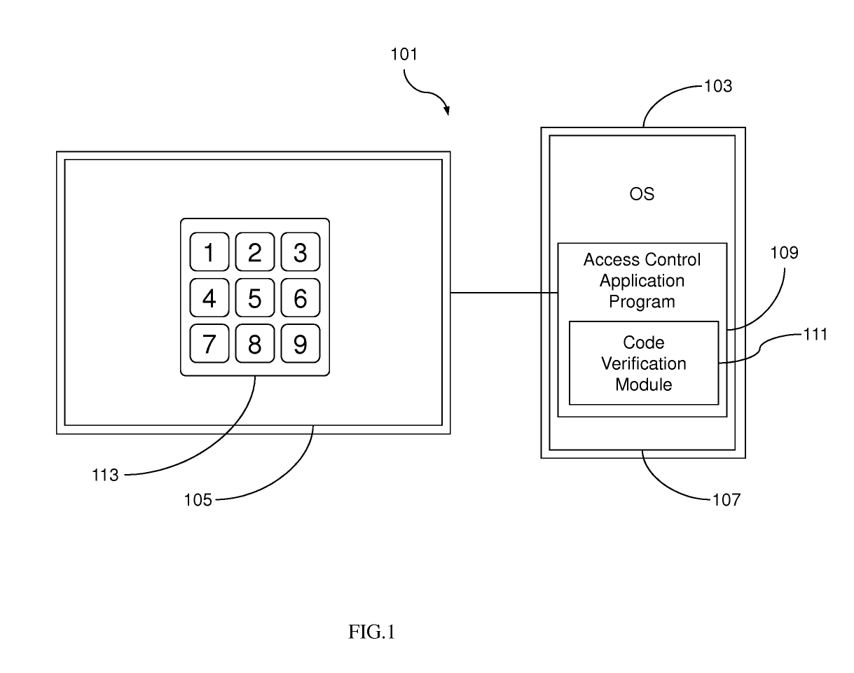

With reference to FIG. 1, an embodiment of the invention comprises a computer system 101 comprising a computer 103 and an associated input/output device in the form of a connected touchscreen 105. The computer 103 is loaded with an operating system (OS) 107 arranged when running to provide a platform for the processing of one or more application programs. In the present embodiment, the computer 103 is loaded with an access control application program 109 comprising a code verification module 111.

The access control application program 109 is arranged to control access an asset or resource in the form of the OS 107 so as to enable only authorized users to access the OS 107. Authorized users are provided with an access code. The computer 103 comprises a processor and memory (not shown), which are protected from unauthorized access so as to maintain the integrity of the access control program 109. In the present embodiment, the access control application program 109 and the code verification module 111 are provided with access to the resources of the computer 103 via a protected path provided by the OS 107. Similarly, the touchscreen 105 is connected to the access control application program 109 via a protected path provided by the OS 107. The OS 107 is also provided with protection from unauthorized access.

On start-up of the OS 107, for example from a sleep mode or boot, the access control application program 109 is arranged to prevent immediate access to the OS 107 and instead to display a keypad 113 on the touchscreen 105. In the present embodiment, the keypad 113 is a nine-digit numeric keypad. The keypad 113 is arranged to enable a user to input an access code.

In the present embodiment, the code comprises a set of four code elements, in the form of numbers. Each code element is associated with a selection time period corresponding to the length of time of the key press for the associated number. In the present embodiment, two discrete time periods are defined in the form of a short and a long time period. The short time period is defined as less than or equal to one second and the long time period is defined as more than one second. The input to the keypad 113 is monitored by the code verification module 111, which is arranged to capture and verify any input access code against a predetermined passcode and if the access code and passcode match a verification of the access code is provided to the access control application program 109. In response to such verification, the access control application program 109 removes to keypad 113 and provides access to the OS 107.

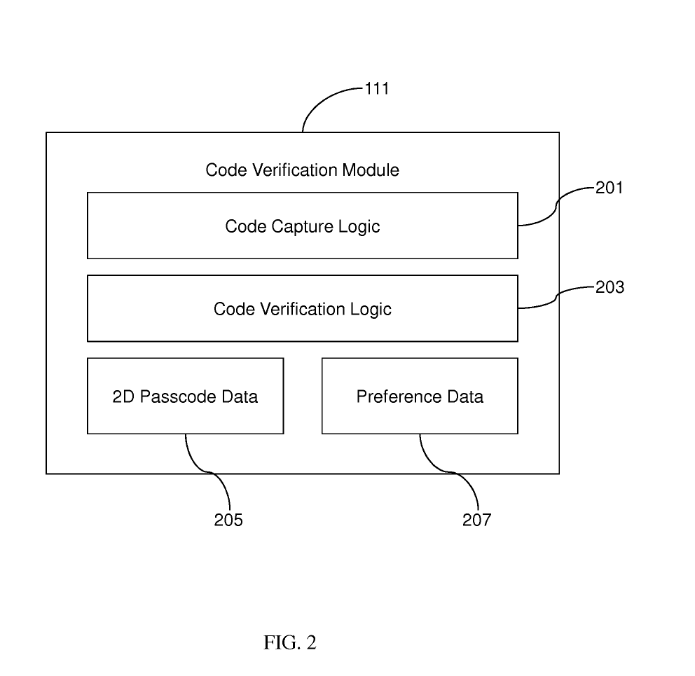

With reference to FIG. 2, the code verification module 111 comprises code capture logic 201, code verification logic 203, two-dimensional (2D) passcode data 205 and preference data 207. In the present embodiment, the code capture logic 201 is arranged to operate in two modes in the form of a programming or code capture mode and a normal operational mode. In the present embodiment, access to the programming or code capture mode is protected by the use of an administrator passcode which a user must enter to switch the code capture logic into the programming or code capture mode. In the programming mode a trusted administrator is permitted to modify or input the relevant set of one or more passcodes and to modify the administrator passcode. In the normal operational mode, the code verification module 111 is arranged to verify input access codes against the set of one or more stored passcodes.

The code capture logic 201 is arranged to monitor inputs to the keypad 113 and to capture each sequence of four pressed keys and associated key-press periods. The key-press periods are captured by a timing function of the code capture logic 201. The timing function monitors the start time for a given key-press and the release or end time for the key-press and from this data calculates the relevant key-press time period (short or long) as describe above. The captured key numbers (1 to 9) and associated time periods (short or long) are then either stored as a passcode or provided to the code verification logic 203 for processing in dependence on the relevant operating mode. In the present embodiment, in response to the capture of an access code, the keypad 113 is disabled and greyed out until the input access code verification process is complete. If the input access code is verified, access to the OS 107 enabled. If the input code is not verified the keypad 113 is re-enabled.

The code verification logic 203 is arranged to receive an input access code from the code capture logic 201 and to compare the access code to the 2D passcode data 205 which represents the correct code for enabling access to the OS 107. If the input access code matches the passcode data 206 in both dimensions, that is, both the numerals and associated time periods are identical, the code verification logic 203 is arranged to output verification of the access code to the access control application program 109 resulting in access to the OS 107 being enabled. If no such match is identified then a verification failure is output to the access control application program 109 resulting in the keypad 113 being re-enabled.

In the present embodiment, the 2D passcode data 205 is represented by an eight-digit sequence of four number and letter pairs. The number represents the relevant code element (1 to 9) and the letter represents the associated time period. For example, the following input:

1, short;

2, long;

3, short; and

4, long,

is represented in the 2D passcode data 205 as follows:
1S2L3S4L.

In the present embodiment, the preference data 207 comprises data that determines parameters used by the code capture logic 201 and the code verification logic 203. In the present embodiment the preferences determine the number of digits in the access code and passcode, the number of relevant time periods for key-presses, the length of the relevant time periods and a limit of the number of incorrect access code attempts before the keypad 113 is locked for a predetermined lock-out period.

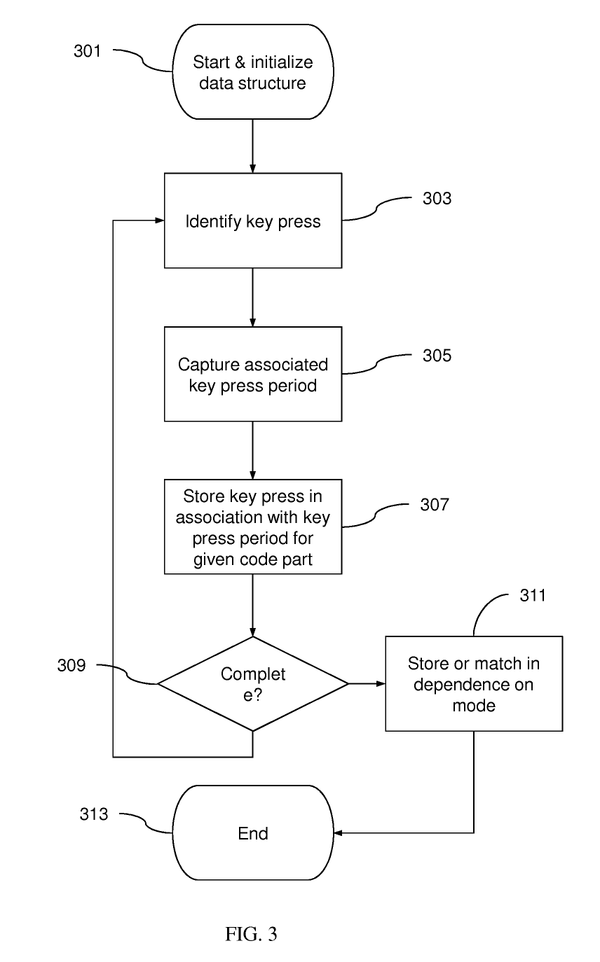

The processing performed by the code capture logic 203 will now be described further with reference to the flow chart of FIG. 3. Processing is initiated at step 301 in response to an input to the keypad 113, a data structure is initialized for storing a predetermined number of code element and key press time period pairs and processing moves to step 303. At step 303 the key-press from the keyboard is identified indicating an input code element and processing moves to step 305. At step 305 the time period for the key press is captured and converted to the relevant time period in accordance with the preference data 207 and processing moves to step 307. At step 307 data representing the input code element and the associated time period are stored in the current data set for the current key press sequence and processing moves to step 309. At step 309 if the predetermined number of code elements has been input, the keypad 113 is grayed out and processing moves to step 311. If not, processing then returns to step 303 and continues as described above. At step 311 the data structure is either stored if the code verification module is operating in programming or code capture mode or provided to the code verification logic 203 if the code verification module 111 is in normal operational mode. Processing of the code capture module then moves to step 313 and ends. If the code verification module 111 is in program mode then at step 311 a new passcode is stored and the keypad 113 is then re-enabled. In the present embodiment, the code verification module 111 then automatically returns to normal operational mode.

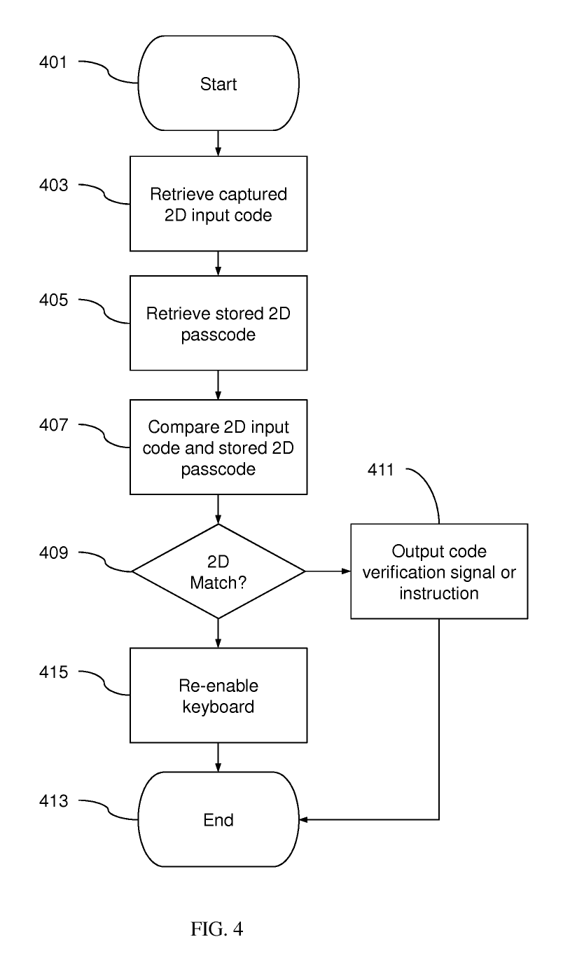

The processing performed by the code verification logic 203 will now be described further with reference to the flow chart of FIG. 4. Processing is initiated at step 401 from step 311 of the processing of the code capture logic 201 and processing moves to step 403. At step 403 the captured input 2D access code is retrieved from the data structure and processing moves to step 405. At step 405 the stored 2D passcode is retrieved from the 2D passcode data 205 and processing moves to step 407. At step 407 the input 2D access code is compared to the stored 2D access code and processing moves to step 409. If the access code matches the passcode then from step 409 processing moves to step 411 where a signal or instruction indicating verification of an input access code is passed to the access control application program 109 so as to enable access to the OS 107. Processing then moves to step 413 and ends. If the access code does not match the passcode then from step 409 processing moves to step 415 where the keyboard 113 is re-enabled to allow a further access code to be input. Processing then moves to step 413 and ends.

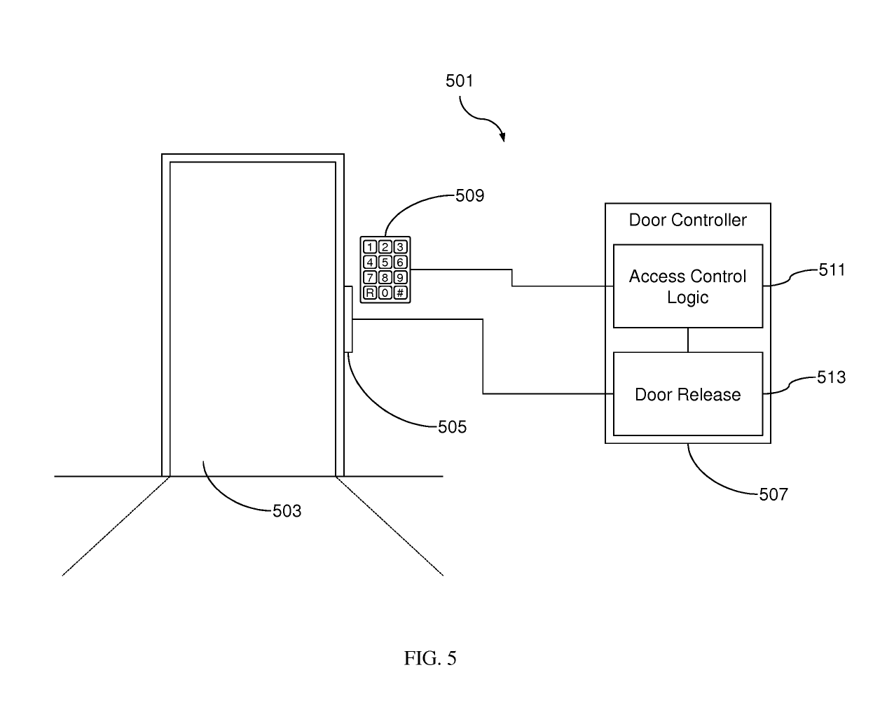

With reference to FIG. 5, another embodiment comprises a door access control system 501 comprising a door 503 having an electrically releasable lock 505. The system 501 further comprises a door controller 507 and a keypad 509. The door controller 507 comprises access control logic 511 and a door release module 513. The keypad 509 has the same function as that of the keypad 113 of FIG. 1 as described herein. The access control logic 311 provides the same functionality as the access control application program 109 of FIG. 1 as described herein. In the present embodiment, a signal or instruction indicating verification of an input access code is passed from the access control logic 511 to the door release module 513 which responds by releasing the lock 505 so as to enable access via the door 503. In the present embodiment, the access control logic is implemented in solid-state electronics.

In a further embodiment, the passcode may comprise one of a predetermined set of two or more different time periods. For example, the time periods may be long (>2 s), medium (1-2 s) or short (<1 s).

In another embodiment, a plurality of passcodes is provided. In a further embodiment, the passcodes are retrieved from a remote source over a suitably secure network connection. In another embodiment, one or more of the passcodes are dynamic, that is, the passcode changes over time or in response to time other suitable factor.

In a further embodiment one or more of the passcode code elements may be provided with an associated time period and one or more code elements may be provided without time periods or have null time periods.

In another embodiment, the code verification process checks only selected code elements or associated time periods. Such selection may be random or predetermined.

As will be understood by those skilled in the art, the protection from unauthorized access to the access control means may be provided by any suitable combination of physical protection or electronic protection such as software, hardware or firmware security mechanisms. Access to the programming or code capture mode of the access control means may be provided by a physical key (electronic or mechanical) or via access to a switch, port or terminal of the relevant apparatus.

As will be understood by those skilled in the art, the keypad may comprise buttons to enable reset of the access code input process or deletion of one or more code element inputs or any other suitable function.

As will be understood by those skilled in the art, any suitable means for inputting a code may be provided such as one or more dials or other visual or physical mechanisms for code input.

As will be understood by those skilled in the art, embodiments of the invention may be implemented in mechanics, electro-mechanics, solid-state, hardware, firmware, software or any combination thereof.

Embodiments of the invention provide a two dimensional passcode having a given number of combinations which is easier for a user to remember that a single dimensional passcode with the same number of combinations. In other words two shorter code sequences, one of characters and the other of time periods, is easier to recall than the combinatorial equivalent sequence of characters.

Disclosed herein is a system for verifying an access code in which the access code comprises one or more code elements having associated time periods.

An embodiment of the invention provides a code verification apparatus comprising: a code input for inputting an access code; a passcode retrieval means for retrieving a passcode; verification logic operable to compare an input access code to a retrieved passcode and in response to the access code matching the passcode to output verification of the access code, wherein the passcode comprises a set of one or more code elements, one or more of the code elements being associated with a respective time period.

Embodiments of the invention provide a two dimensional passcode having a given number of combinations which is easier for a user to remember that a single dimensional passcode with the same number of combinations.

The input access code may comprise a set of one or more selected code elements and respective selection time periods. Each code element in the access code may be selected by a user and the respective time period determined by the time period of the user selection of the associated code element. Each code element in the input access code may be selected by activating a button on a user interface and the respective time period determined by the time period for which the button is activated. Each time period in the passcode may comprise data representing one of a set of two or more discrete time periods. The passcode may comprise a sequence of code parts and respective time periods. The output verification may be arranged to enable access to a resource or asset. The output verification may be arranged to release a lock on a resource or asset. The passcode may comprise one or more code elements without an associated time period.

Another embodiment comprises a combination lock comprising a code verification apparatus comprising: a code input for inputting an access code; a passcode retrieval means for retrieving a passcode; verification logic operable to compare an input access code to a retrieved passcode and in response to the access code matching the passcode to output verification of the access code, wherein the passcode comprises a set of one or more code elements, one or more of the code elements being associated with a respective time period.

Embodiment of the invention provides two shorter code sequences, one of characters and the other of time periods, which is easier to recall than the combinatorial equivalent sequence of characters.

A further embodiment provides a method of code verification comprising the steps of: inputting an access code; retrieving a passcode comprising a set of one or more code elements, one or more of the code elements being associated with a respective time period; comparing an input access code to the retrieved passcode and in response to the access code matching the passcode outputting verification of the access code.

Another embodiment provides a computer program stored on a computer readable medium and loadable into the internal memory of a digital computer, comprising software code portions, when said program is run on a computer, for performing a method of code verification comprising the steps of: inputting an access code; retrieving a passcode comprising a set of one or more code elements, one or more of the code elements being associated with a respective time period; comparing an input access code to the retrieved passcode and in response to the access code matching the passcode outputting verification of the access code.

A further embodiment provides a method or apparatus substantially as described with reference to the figures.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of the representative apparatus and method, and illustrative examples shown and described. Accordingly, departures may be made from such details without departure from the scope of applicant's general inventive concept.

What is claimed is:

1. A code verification apparatus comprising:
a code input device for inputting an access code;
a passcode retrieval hardware component for retrieving a passcode; and
a verification logic operable to:
compare an input access code to a retrieved passcode, and
in response to the input access code matching the retrieved passcode, output verification of the access code, wherein the passcode comprises a set of one or more code elements, and wherein one or more of the code elements are associated with a respective time period.

2. The apparatus according to claim 1, wherein the input access code comprises a set of one or more selected code elements and respective selection time periods.

3. The apparatus according to claim 1, wherein each code element in the access code is selected by a user, and wherein the respective time period is determined by a time period of a user selection of an associated code element.

4. The apparatus according to claim 1, wherein each code element in the access code is selected by activating a button on a user interface, and wherein the respective time period is determined by a time period for which the button is activated.

5. The apparatus according to claim 1, wherein each time period in the passcode comprises data representing one of a set of two or more discrete time periods.

6. The apparatus according to claim 1, wherein the passcode comprises a sequence of code parts and respective time periods.

7. The apparatus according to claim 1, wherein the output verification enables access to a resource.

8. The apparatus according to claim 1, wherein the output verification releases a lock on a resource.

9. The apparatus according to claim 1, wherein the passcode comprises one or more code elements without an associated time period.

10. A method of code verification, the method comprising:
receiving, by one or more processors, an input of an access code;
retrieving, by one or more processors, a passcode comprising a set of one or more code elements, wherein one or more of the code elements are associated with a respective time period;
comparing, by one or more processors, an input access code to the retrieved passcode; and
in response to the input access code matching the passcode, outputting, by one or more processors, a verification of the access code.

11. The method according to claim 10, wherein the input access code comprises a set of one or more selected code elements and respective selection time periods.

12. The method according to claim 10, wherein each code element in the access code is selected by a user, and wherein the respective time period is determined by a time period of a user selection of an associated code element.

13. The method according to claim 10, wherein each code element in the input access code is selected by activating a button on a user interface, and wherein the respective time period is determined by a time period for which the button is activated.

14. The method according to claim 10, wherein each time period in the passcode comprises data representing one of a set of two or more discrete time periods.

15. The method according to claim 10, wherein the passcode comprises a sequence of code parts and respective time periods.

16. The method according to claim 10, wherein output verification enables access to a resource.

17. The method according to claim 10, wherein the output verification releases a lock on a resource.

18. The method according to claim 10, wherein the passcode comprises one or more code elements without an associated time period.

19. A computer program product for verifying code, the computer program product comprising a computer readable storage medium having program code embodied therewith, wherein the computer readable storage medium is not a transitory signal per se, and wherein the program code is readable and executable by a processor to perform a method comprising:
receiving an input of an access code;
retrieving a passcode comprising a set of one or more code elements, wherein one or more of the code elements are associated with a respective time period;
comparing an input access code to the retrieved passcode; and
in response to the input access code matching the passcode, outputting a verification of the access code.

20. The computer program product of claim 19, wherein the input access code comprises a set of one or more selected code elements and respective selection time periods.
